(19) United States
(12) Patent Application Publication
(10) Pub. No.: US 2009/0238255 A1
(43) Pub. Date: Sep. 24, 2009

(54) Estimation of Error Propagation Probability to Improve Performance of Decision-Feedback Based Systems

(75) Inventors: Chan Wing Chau, Hong Kong Sar (CN); Zhao Xueyuan, Hong Kong Sar (CN); Pan Zhengang, Hong Kong Sar (CN); Lo Chi Ming, Hong Kong Sar (CN); Derek Lee, Jordan (HK)

Correspondence Address: FULBRIGHT & JAWORSKI L.L.P, 2200 ROSS AVENUE, SUITE 2800, DALLAS, TX, 75201-2784, US

(73) Assignee: Hong Kong Applied Science and Technology Research Institute Co, Ltd., Shatin (CN)

(21) Appl. No.: 12/054,221

(22) Filed: Mar. 24, 2008

(51) Int. Cl. H04B 17/00; H04B 3/46; H04Q 1/20

(52) U.S. Cl. 375/227

(57) ABSTRACT

A decision feedback-based communication system comprising a unit for computing an estimated Error Propagation Probability (EPP) for a plurality of received signals, and a unit for receiving the EPP estimation and improving detected signal quality based thereon. The system can be a coded system or an uncoded system.

### TECHNICAL FIELD

The present description is related to decision feedback-based communication systems and, more specifically, is related to minimizing the effects of error propagation in decision feedback-based communication systems.

### BACKGROUND OF THE INVENTION

Various decision feedback-based systems exist in the art currently. Examples include Decision-Feedback Equalizers (DFEs), Vertical Bell Labs Layered Space Time (V-BLAST) systems, multi-user detection and multi-code detection (as in Code Division Multiple Access, CDMA) systems, and the like. Equation (1) gives a good description of a basic decision feedback-based system:

y=Hx+n (1)

For a Single Input Single Output (SISO) multipath channel system, y is a vector that gives the temporal sequence of received symbols, H is a matrix giving the channel state information (e.g., attenuation), x is a vector giving the temporal sequence of transmitted symbols, and n is a noise (or interference) vector. FIG. 1 is an illustration of a basic, prior art multipath channel scheme in a DFE SISO system. Blocks 101 represent N stages in the DFE system, with each stage producing a value \hat{x}, which is an estimate of the respective, transmitted symbol at each stage. Component 102 is a more detailed view of a single stage of blocks 101. The DFE system makes a decision regarding the values of the scalar components of x (thereby producing values for \hat{x}) and then subtracts the probable noise values therefrom.

Estimates of noise for a first stage often affect the estimates of noise for subsequent stages, such that errors tend to propagate. Thus, when a detection error is made at one symbol, the error can cause increased interference in subsequent symbols. This phenomenon is generally referred to as “error propagation,” and it can occur in most, if not all, decision feedback-based systems. For example, in a typical coded V-BLAST system that supports optimal decoding, a first symbol is decoded, and an interference constant is determined and subtracted from the received signal. The decoder makes a decision as to whether a particular symbol is reliable or unreliable based on its perceived Signal to Noise Ratio (SNR). SNR can then be used by the system to weight the received symbols, with higher SNR symbols receiving more weight. When error propagation happens, the SNR that is perceived by the decoder is wrong. The decoder may then assume that the SNR of a particular symbol is very good because it assumes that the interference has been subtracted due to a correct decision previously. However, if there was an error in detecting the previous stage, the interference in the current stage has probably not been wholly subtracted and may even have increased. Error propagation can cause a large gap between the true SNR and the assumed SNR, which can lead to, inter alia, incorrect assumptions regarding reliability of subsequent symbols as well as incorrect subtractions of assumed interference.

In coded systems (e.g., those that use Quadrature Amplitude Modulation), error propagation can manifest itself in large code word error rates, Bit Error Rates (BERs), Frame Error Rates (FERs), or other measurements of lost information. In uncoded systems, an error typically propagates by only a few symbols before it is cut off. However, even such limited error propagation can still corrupt entire frames of information. Therefore, reducing the effects of error propagation is important in both coded and uncoded systems.

Various mitigation techniques have been used and/or proposed in the past. One such technique is iterative interference cancellation (i.e., parallel interference cancellation, spatial interference cancellation, and new decoding order schemes). Some scholars have proposed calculating an expected interference power and taking it into account in the detection. Still other people have proposed using different coding rates across different substreams to mitigate the effect of the error propagation. In such systems, lower code rates can be used at times in some substreams to decrease the chance of making error. By doing this, then, the chance of causing error propagation can be reduced. Similar to using different code rates across substreams, different transmit powers across different substreams can be used. In one such example, systems allocate stronger power for some substreams so as to decrease the error propagation. Results of previous solutions have not produced satisfactory results for some more sensitive systems, though, and some solutions (e.g., using different coding rates and transmit powers) can often require extensive hardware and software changes in transmitters.

### BRIEF SUMMARY OF THE INVENTION

Various embodiments of the present invention are directed to systems, methods, and computer program products which use an error propagation probability to improve the performance of decision feedback-based communication systems. In one embodiment, a decision feedback-based communication system calculates error propagation probability for each of a plurality of received symbols.

Techniques are disclosed for utilizing the estimates of error propagation probability. One example of utilizing the error propagation probability resides in a detecting process. Before detection, the error propagation probability for each symbol is compared to a threshold value, and when the threshold is exceeded, the detector takes appropriate action to compensate for the high risk of error propagation. An example of such action is switching on non-decision feedback-based filters (e.g., Minimum Mean Squared Error filters).

Another example resides in a decoding process. After detecting but before decoding, each of the symbols is assigned a weight based, at least in part, on its estimate of error propagation probability. The decoder then relies less on symbols that have a higher risk of error propagation.

Some example embodiments use both a detector-based mitigation approach and a decoder-based mitigation approach. Further, some embodiments only employ one mitigation approach.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an illustration of a basic, prior art multipath channel scheme in a DFE SISO system;

FIG. 2 is an illustration of an exemplary system adapted according to one embodiment of the invention;

FIG. 3 is an illustration of an exemplary system adapted according to one embodiment of the present invention;

FIG. 4 is an illustration of an exemplary method adapted according to one embodiment of the invention and performed by the system of FIG. 3; and

FIG. 5 illustrates an example computer system adapted according to embodiments of the present invention;

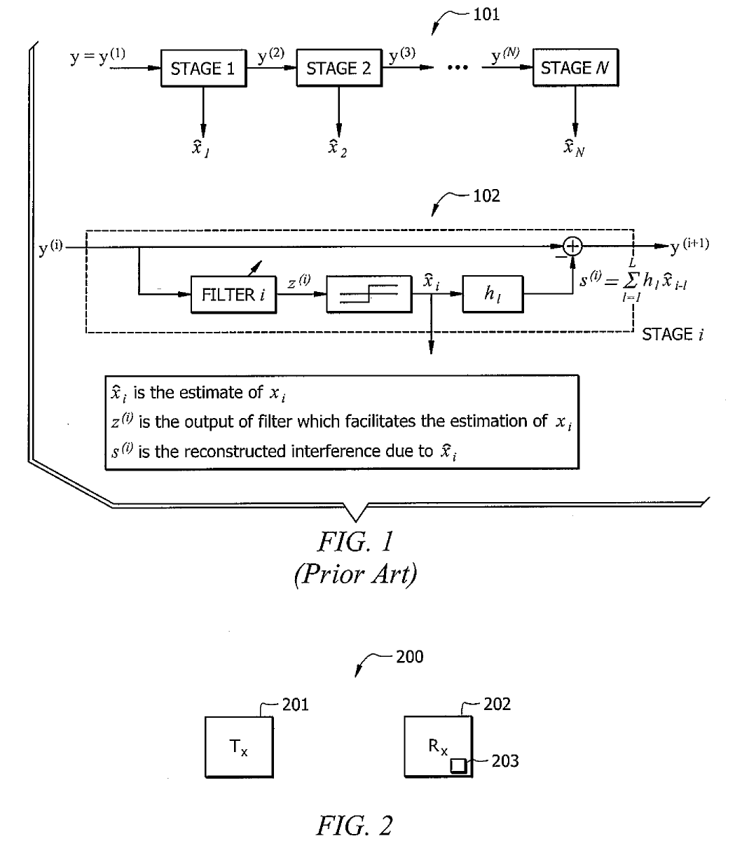

### DETAILED DESCRIPTION OF THE INVENTION

FIG. 2 is an illustration of exemplary system 200 adapted according to one embodiment of the invention. System 200 is a decision feedback-based communication system with transmitter 201 and receiver 202. In some embodiments, transmitter 201 includes one transmitting component, and in other embodiments, transmitter 201 includes more than one transmitting component. Thus, system 200 can include a Single Input Single Output (SISO) system, a Multiple Input Single Output (MISO) system, a Single Input Multiple Output (SIMO) system, or a Multiple Input Multiple Output (MIMO) system. System 200 may be adapted for use in such applications as CDMA systems, V-BLAST systems, and the like.

Similarly, receiver 202 may include one or more receiving components, depending on the embodiment. Receiver 202 also includes component 203, which calculates error propagation probability (EPP) for units of data (e.g., symbols, stages) and uses the EPP calculation to improve detected signal quality. Once EPP is estimated, it can be used in a variety of ways to improve detected signal quality, such as applying one or more filters as a result of EPP estimation and/or applying weighting to data units based on EPP. Each of these techniques is described in more detail below, and it should be noted that the invention is not limited to such techniques, as other techniques may be adapted for use with various embodiments.

Various ways for calculating estimated EPP exist in the art and can be used in some embodiments of the invention. One way of viewing EPP calculation techniques is to divide them into two categories: those that use a posteriori information (API) in the calculation and those that do not use API. One example of API is an observed value of a received signal (e.g., a γ value in Equation (1), above). Typically, a non-API technique for calculating EPP uses only symbol energy and noise power in its calculation. API-based techniques use a value of a received symbol to calculate EPP. In general, API-based techniques are more accurate and can change from symbol-to-symbol, thereby providing more information at given points in time.

An example technique for calculating EPP using API is given by the equations below. The example technique can be used to calculate EPP in a decision feedback based system with a plurality of stages. The technique below is especially useful for estimating EPP in a V-BLAST system. First, SE^{(f)} is the event that symbol error has occurred in the i^{th} stage. EP⁽ⁱ⁾ is the event that error propagation has occurred in the i^{th} stage. P_{EP}⁽ⁱ⁾ is the probability of error propagation in the i^{th} stage, and it is given by Equation (2), where z⁽ⁱ⁾ is API for the i^{th} stage (e.g., the output of the filter which facilitates the estimation of \hat{x}), and where z⁽ⁱ⁾={z⁽¹⁾,z⁽²⁾, . . . }.

P_{EP}⁽ⁱ⁾=Pr(EP⁽ⁱ⁾|z⁽ⁱ⁾) (2)

Thus, for the first stage (i=1), Equation (2) is shown as follows:

P_{EP}^{(l)}=Pr(SE^{(l)}|z^{(l)} (3)

Further, for stages after the first stage (i>1), Equation (4) is derived as follows.

$$\begin{matrix}{P}_{EP}^{( i )} = Pr ( {EP}^{( i )} \vert {z}^{( i )} ) \\ = Pr ( {SE}^{( i )} , {\overline{EP}}^{( i - 1 )} \vert {z}^{( i )} ) + Pr ( {EP}^{( i - 1 )} \vert {z}^{( i )} ) \\ = Pr ( {SE}^{( i )} \vert {\overline{EP}}^{( i - 1 )} , {z}^{( i )} ) Pr ( {\overline{EP}}^{( i - 1 )} \vert {z}^{( i )} ) + Pr ( {EP}^{( i - 1 )} \vert {z}^{( i )} )\end{matrix} \qquad ( 4 )$$

Various embodiments of the invention estimate Equation (2) and Pr(EP⁽ⁱ⁻¹⁾|z⁽ⁱ⁾) recursively for every stage i. In Equation (4) there is a term,

Pr(SE⁽ⁱ⁾| E̅P̅⁽ⁱ⁻¹⁾,z⁽ⁱ⁾)

which can be further defined in the following equations in terms of \hat{x} (the estimate of x at a given stage):

$$\begin{matrix}= Pr ( {SE}^{( i )} \vert {\overline{EP}}^{( i - 1 )} , {z}^{( i )} ) \\ = 1 - \frac{f ( {z}^{( i )} \vert {\hat{x}}_{i} ) Pr ( {\hat{x}}_{i} )}{{\sum }_{x ∈ D} f ( {z}^{( i )} \vert {\hat{x}}_{i} ) Pr ( {\hat{x}}_{i} )} \\ = 1 - ( \frac{{e}^{\frac{{\vert {z}^{( i )} - {\hat{x}}_{i} \vert}^{2}}{{σ}_{i}^{2}}}}{{\sum }_{{\hat{x}}_{i} ∈ {D}_{i}} {e}^{\frac{{\vert {z}^{( i )} - {\hat{x}}_{i} \vert}^{2}}{{σ}_{i}^{2}}}} )\end{matrix} \qquad ( 5 )$$

In Equation (5), Dᵢ is the set of constellation points in the i^{th} substream, and σ²ᵢ is the noise power variance in the i^{th} substream. Using Equations (2)-(5) above, it is possible to calculate the estimated power of interference and noise at the i^{th} stage, conditioned on the event that there is error propagation in any of the previous (i−1) stages.

$$\begin{matrix}\frac{P ( {\overline{EP}}^{( i - 1 )} \vert {z}^{( i )} )}{P ( {EP}^{( i - 1 )} \vert {z}^{( i )} )} = \frac{P ( {z}_{i}^{( i )} , {\overline{EP}}^{( i - 1 )} \vert {z}^{( i - 1 )} )}{P ( {z}_{i}^{( i )} , {EP}^{( i - 1 )} , \vert {z}^{( i - 1 )} )} \\ = \frac{P ( {z}_{i}^{( i )} \vert {\overline{EP}}^{( i - 1 )} , {z}^{( i - 1 )} ) P ( {\overline{EP}}^{( i - 1 )} \vert {z}^{( i - 1 )} )}{P ( {z}_{i}^{( i )} \vert {EP}^{( i - 1 )} , {z}^{( i - 1 )} ) P ( {EP}^{( i - 1 )} \vert {z}^{( i - 1 )} )} \\ \approx \frac{P ( {z}_{i}^{( i )} \vert {\overline{EP}}^{( i - 1 )} )}{P ( {z}_{i}^{( i )} \vert {EP}^{( i - 1 )} )} \cdot \frac{P ( {\overline{EP}}^{( i - 1 )} \vert {z}^{( i - 1 )} )}{P ( {EP}^{( i - 1 )} \vert {z}^{( i - 1 )} )} \\ \approx \frac{P ( {z}_{i}^{( i )} \vert {\overline{EP}}^{( i - 1 )} )}{{δ}^{( i )}} \cdot \frac{P ( {\overline{EP}}^{( i - 1 )} \vert {z}^{( i - 1 )} )}{P ( {EP}^{( i - 1 )} \vert {z}^{( i - 1 )} )} = {θ}^{( i )}\end{matrix} \qquad ( 6 )$$

The term δ⁽ⁱ⁾ is used to approximate Pr(zᵢ⁽ⁱ⁾|EP⁽ⁱ⁻¹⁾), and is given in Equation (7), wherein P_{IN} is interference power, and wherein γ is channel gain,

$${δ}^{( i )} = \frac{1}{π {P}_{IN}^{( i )}} {e}^{\frac{{\vert {z}_{i}^{( i )} - {γ}_{i} {\hat{x}}_{i} \vert}^{2}}{{P}_{IN}^{( i )}}} \qquad ( 7 )$$

β⁽ⁱ⁾ is the estimated EPP and is given by Equation (8):

β⁽ⁱ⁾=(1+θ⁽ⁱ⁾)⁻¹ (8)

P_{IN}⁽ⁱ⁾ represents the power of interference and noise at the i^{th} stage, conditioned on the event that there is error propagation in the previous stage. P_{IN}⁽ⁱ⁾ is approximated by the worst case interference power for a given stage and is equal to the sum of the interference from all detected substreams, as in Equation (9):

$${P}_{IN}^{( i )} = {\sum }_{j = 1}^{i - 1} {σ}_{{e}_{i}}^{2} {\vert {g}^{{( i )}^{H}} {h}_{{k}_{i}} \vert}^{2} + {σ}_{n}^{2} \vert {g}^{{( i )}^{H}} {g}^{( i )} \vert \qquad ( 9 )$$

In Equation (9), σ²ₑⱼ is the variance of detection error of the j^{th} detected substream, σ²ₙ is the noise power per receive antenna, hₖⱼ is the column channel vector of substream kⱼ, detected at the j^{th} stage, and g⁽ⁱ⁾ is the filtering vector for the i^{th} detected substream. Note that the technique shown above to calculate EPP is iterative and can be applied at each stage.

A further technique that uses EPP estimation to mitigate the effects of error propagation includes making the detector adaptive so that it responds to EPP by using a non-decision feedback-based technique in addition to or alternatively to a decision feedback-based technique. In one example, a V-BLAST detector includes a Minimum Mean Squared Error (MMSE) filter for each stage. For each stage, the system calculates EPP and compares the value of EPP to a threshold that represents a level of risk of error propagation. If it is determined that the EPP exceeds the threshold (or in some cases, meets the threshold) the detector switches the MMSE filters on, at least for the remaining stages (and in some embodiments, for the current stage as well). The system may or may not continue to calculate EPP for the remaining stages.

MMSE is not a decision feedback-based technique, such that applying MMSE filters at each stage makes the risk of error propagation moot. While V-BLAST and MMSE are specifically mentioned in the example above, it should be noted that the invention is not limited thereto, as other decision feedback-based systems may be used, and other non-decision feedback-based techniques, other than MMSE, may be used as well. Further, adaptive detecting can be implemented in both coded and uncoded systems, since it is independent of coding.

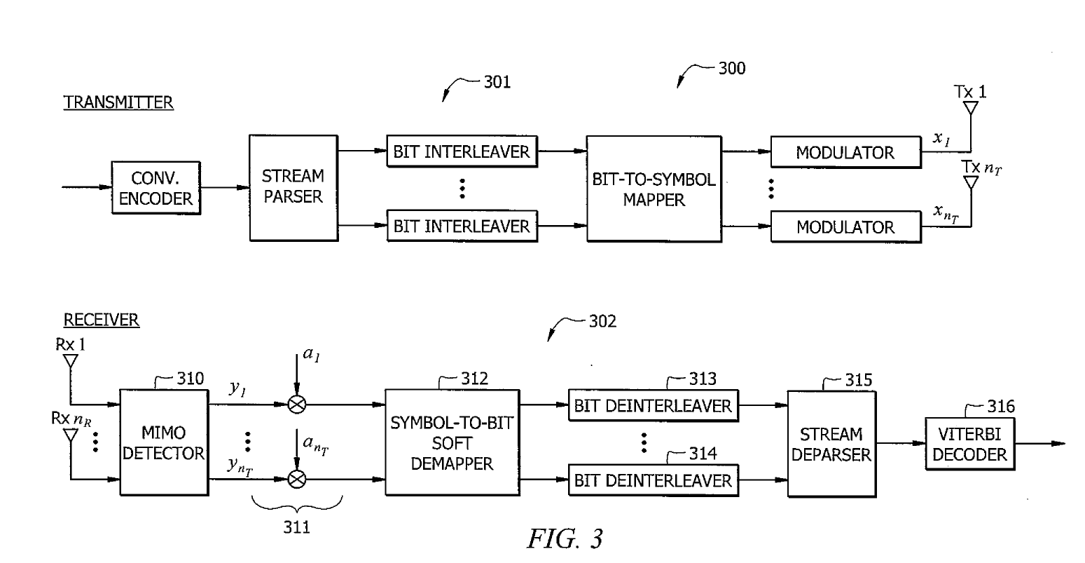

Another method using EPP to improve received signal quality employs weighting of the detected symbols based on the EPP estimation. For example, after symbols have been detected, but before they have been decoded, a system may assign weights to the symbols, thereby indicating a level of risk of error propagation associated with each symbol. Lower weights can be assigned to symbols that have higher EPP estimates. Typically, the optimal weighting on the symbols is equal to the Signal to Interference Plus Noise Ratios (SINRs) of the symbols. Using convolutional code with bit-interleaved-coded-modulation (BICM) and a Viterbi decoder (e.g., 316 of FIG. 3) as an example, the weighting αₖ is multiplied to the symbol yₖ, before the symbol is fed into a soft-demapper. (e.g., 312 of FIG. 3). The outputs of the soft-demapper are the log-likelihoods of the bits demapped from the symbols [Inkyu Lee, Albert M. Chan, and Carl-Erik W. Sundberg, “Space-Time Bit-Interleaved Coded Modulation for OFDM Systems,” IEEE Transactions on Signal Processing, vol. 52, no. 3, March 2004]. Assuming the noise is additive white Gaussian, with the above scaling by αₖ, it can be shown easily that these bit log-likelihoods are exact. By feeding these bit log-likelihoods into the conventional Viterbi decoder for binary convolutional code the exact log-likelihood branch metric will be computed and the optimal codeword can be found.

An example weighting is computed using Equation (10), wherein weightings are computed as effective symbol SINRs, and wherein γᵢ is a post-detection SINR of the ith detected stage, assuming no error propagation, and P_{SE}(γ) is the symbol error probability function at SINR γ for the constellation of the substream, where this function is obtained either analytically or empirically.

P_{SE}(\tilde{y}ᵢ)≈Pr(SE⁽ⁱ⁾|γᵢ, E̅P̅⁽ⁱ⁻¹⁾)(1−P_{EP}⁽ⁱ⁻¹⁾)+Pr(SE⁽ⁱ⁾|γᵢ,EP⁽ⁱ⁻¹⁾)P_{EP}⁽ⁱ⁻¹⁾, (10)

We can find \tilde{y}ᵢ, such that Equation (10) is satisfied. The term, P_{EP}, can be calculated using Equation (4). The term, Pr(SE⁽ⁱ⁾|γᵢ, EP⁽ⁱ⁻¹⁾), in Equation (10) is estimated assuming the resultant noise plus interference is zero mean Gaussian with variance αP_{IN}⁽ⁱ⁾, where alpha is a parameter greater than or equal to one. Alpha is used to compensate for the invalidity of the assumption that the noise-plus-interference is not Gaussian by being more conservative in the estimate of noise power. Some simulations setting alpha equal to two produce reasonable results. Weighting factors are given by Equation (11).

αᵢ=P_{SE}⁻¹(Pr(SE⁽ⁱ⁾|γᵢ, E̅P̅⁽ⁱ⁻¹⁾)+Pr(SE⁽ⁱ⁾|γᵢ,EP⁽ⁱ⁻¹⁾)P_{EP}⁽ⁱ⁻¹⁾. (1)

The weighting technique described is implemented in the decoding stage of signal reception and, thus, is not applicable to uncoded systems. However, many embodiments that include coded systems can employ both adaptive detecting as well as symbol weighting to have a two-tiered error propagation mitigation scheme, such as that shown in FIG. 3.

FIG. 3 is an illustration of exemplary system 300 adapted according to one embodiment of the present invention. System 300 includes transmitter 301 and receiver 302. In the example of FIG. 3, a typical MIMO transmitter is shown. In fact, in many embodiments, the inventive features reside in the receiver only, such that no modifications to transmitters are required in order to improve the quality of received signals. However, the invention does not exclude modifications to transmitters. Further, while FIG. 3 follows a basic V-BLAST architecture, any kind of decision feedback-based communication system (e.g., a CDMA system, a Decision Feedback Equalizer (DFE) system, a multi-user detection system, and the like) can be adapted according one or more embodiments of the invention.

MIMO detector 310 receives the symbols and performs detecting. In some systems, MIMO detector 310 is embodied in a semiconductor chip (general purpose or application-specific) that may also include components 311-316. In this example, MIMO detector 310 is enhanced to perform the functions of an adaptive detector. Thus, MIMO detector 310 estimates EPP and uses the estimate to switch on one or more filters. In one example, an adaptive V-BLAST detector is used as detector 310 and switches on MMSE filters (not shown) if EPP is calculated to be at or above a threshold.

Further in this example, receiver 302 performs weighting based on estimated EPP. Such weights are applied at components 311 to each of the symbols. The weightings are shown by αₗ, . . . , αn_{ᵣ} and are associated with the symbols from the n_{T} substreams. Note that system 200 includes two techniques to enhance received signal quality—adaptive detecting and EPP-based weighting. Other embodiments may apply only one of the techniques. In fact, it is possible that systems can use other techniques not mentioned herein to improve received signal quality, and such systems fall within the scope of embodiments of the present invention as long as they use EPP estimates to mitigate the effects of error propagation.

The logic to perform EPP estimation and to apply the estimates to improve received signal quality may be included in hardware, software, or a combination of the two. Some embodiments of the invention include an improved MIMO receiver chipset for use in a variety of applications. Other embodiments include software that can be stored on a computer readable medium, such as RAM, ROM, optical storage media, a computer hard drive, and/or the like.

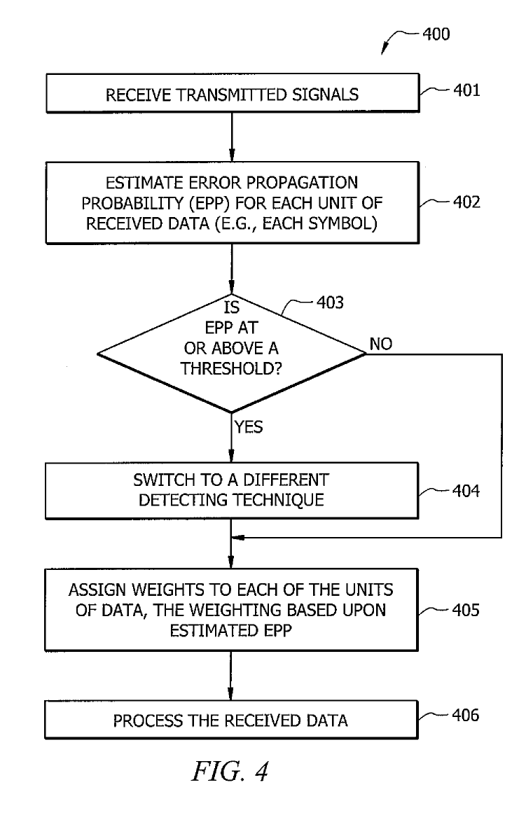

Various embodiments of the invention are methods that are performed by one or more processing devices in a decision feedback-based communication system. FIG. 4 is an illustration of exemplary method 400 adapted according to one embodiment of the invention and performed by the system of FIG. 3.

In step 401, transmitted signals are received. At step 402, the system estimates EPP for each symbol, as described above. It should be noted that the technique described above to calculate EPP is one of many possible ways to calculate EPP, and embodiments of the invention are not limited thereto. In fact, different embodiments of the invention can use different techniques, now known or later developed to calculate EPP. Further, some embodiments may use API to calculate EPP, while other embodiments may forgo the use of API while still calculating EPP.

The system then uses the estimated EPP to mitigate the effects of error propagation. For instance, in step 403, the system examines the estimated EPP for a given symbol and compares it to a threshold EPP value. If the EPP for a symbol exceeds the threshold, then the system switches to another detecting technique (e.g., MMSE) for that symbol and subsequent symbols at step 404. The system may switch back to the first technique (e.g., V-BLAST), after a certain number of symbols that can be set by a user, set statically, or dynamically determined by the system. The threshold may also be set statically, set by a user, or dynamically by the system, and the threshold usually corresponds to an EPP that is known to indicate a likelihood of poor performance.

The system continues to step 405, where weights are assigned to the detected symbols. Decoding is then performed, as explained above. With the use of adaptive detecting and EPP-based weighting, estimates of symbol SNR are typically more reliable than that of systems that rely on prior art solutions. With reliable SNR estimates, the system is able to construct bits and frames from the symbols with a lower likelihood of data corruption.

In step 406, the system processes the data in a same or similar manner to that used by conventional systems. For example, system 300 may be part of a WiFi (IEEE 802.11) router that then routes the data to appropriate Internet Protocol (IP) addresses. In another example, system 300 is included in a wireless handset (e.g., a phone or other portable computing device), and the data is used by the device as programs, text, voice, video, or the like.

While method 400 is shown as a series of discrete, sequential steps, various embodiments of the invention are not limited thereto. Various embodiments may add, delete, modify, or rearrange various steps. For instance, step 403 may be applied to each unit of received data until the threshold is exceeded, at which point step 404 is performed. Further, the detection may be performed for a number of stages before method 400 moves on to decoding at step 405. Additionally, some embodiments perform weighting, but not adaptive detection, whereas other embodiments perform adaptive detection, but not weighting.

Various embodiments of the invention provide advantages over prior art systems. For example, as mentioned above, estimates of symbol SNR are generally more reliable than that of typical prior art systems that do not take EPP into account. In fact, improved performance has been confirmed in simulated testing.

Another advantage of some embodiments is that improved performance can be accomplished with few or no changes to the transmitter portion of a decision-feedback-based communication system. For example, in a wireless telephone CDMA system, some improved performance can be had by including enhanced chipsets in handheld devices. Since the change in operation is limited to the operation of the handheld device only, there is no need to make expensive upgrades to the network base stations. Thus, in some instances, implementing embodiments of the invention can be as simple as reprogramming devices or including enhanced chipsets in devices when they are manufactured or upgraded. Further, the other way around is also true and even more important in some scenarios. For instance, a performance gain can be achieved by changing the receiver at the base station, without altering the hardware/software in the handsets. The cost savings in general can potentially be even larger, as the number of handsets in a given system is typically much, much larger than the number of base stations.

However, it is understood that both the handsets and the network base stations transmit during communications. Thus, some embodiments include adapting wireless network base stations, WiFi access points, WiMAX base stations, etc., according to the techniques described herein to improve signal reception at those devices.

When implemented via computer-executable instructions, various elements of embodiments of the present invention are in essence the software code defining the operations of such various elements. The executable instructions or software code may be obtained from a readable medium (e.g., a hard drive media, optical media, RAM, EPROM, EEPROM, tape media, cartridge media, flash memory, ROM, memory stick, and/or the like). In fact, readable media can include any medium that can store information.

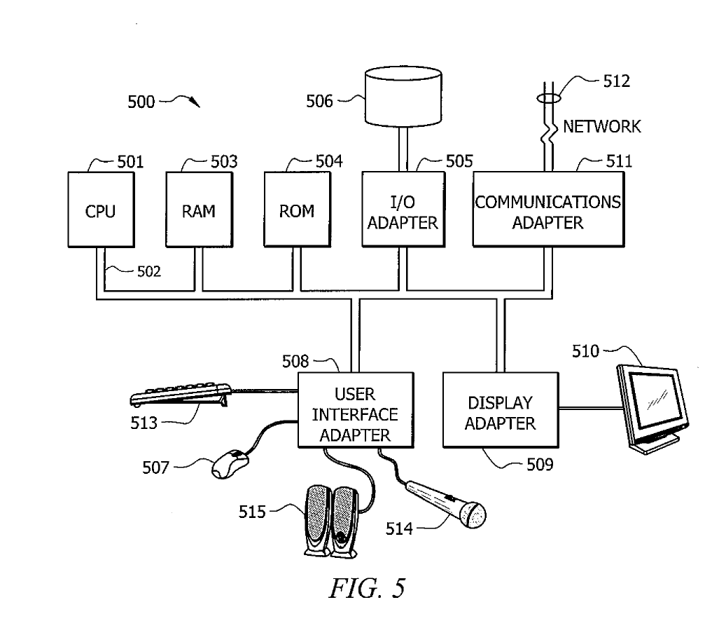

FIG. 5 illustrates an example computer system 500 adapted according to embodiments of the present invention. That is, computer system 500 comprises an example system on which embodiments of the present invention may be implemented (e.g., a laptop computer with a transceiver operable to use EPP to mitigate the effects of error propagation). Central processing unit (CPU) 501 is coupled to system bus 502. CPU 501 may be any general purpose CPU. However, the present invention is not restricted by the architecture of CPU 501 as long as CPU 501 supports the inventive operations as described herein. CPU 501 may execute the various logical instructions according to embodiments of the present invention. For example, one or more CPUs, such as CPU 501, may execute machine-level instructions according to the exemplary operational flows described above in conjunction with FIG. 4.

Computer system 500 also preferably includes random access memory (RAM) 503, which may be SRAM, DRAM, SDRAM, or the like. Computer system 500 preferably includes read-only memory (ROM) 504 which may be PROM, EPROM, EEPROM, or the like. RAM 503 and ROM 504 hold user and system data and programs, as is well known in the art.

Computer system 500 also preferably includes input/output (I/O) adapter 505, communications adapter 511, user interface adapter 508, and display adapter 509. I/O adapter 505, user interface adapter 509, and/or communications adapter 511 may, in certain embodiments, enable a user to interact with computer system 500 in order to input information, such as media selections.

I/O adapter 505 preferably connects to storage device(s) 506, such as one or more of hard drive, compact disc (CD) drive, floppy disk drive, tape drive, etc. to computer system 500. The storage devices may be utilized when RAM 503 is insufficient for the memory requirements associated with storing data. Communications adapter 511 is preferably adapted to couple computer system 500 to network 512 (e.g., the Internet, a LAN, a cellular network, etc.). User interface adapter 508 couples user input devices, such as keyboard 513, pointing device 507, and microphone 514 and/or output devices, such as speaker(s) 515 to computer system 500. Display adapter 509 is driven by CPU 501 to control the display on display device 510 to, for example, display a choice of media or to display the media as it is played.

While FIG. 5 shows a general-purpose computer, it should be noted that the exact configuration of a portion of a system according to various embodiments may be slightly different. For example, systems according to one or more embodiments may be any kind of processor-based device, such as a cell phone, a Personal Digital Assistant, a wireless base station, and/or the like. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A decision feedback-based communication system comprising:
a unit for receiving a plurality of signals;
a unit for computing an estimated Error Propagation Probability (EPP) for said received signals; and
a unit for receiving the EPP estimation and improving detected signal quality based thereon.

2. The system of claim 1, wherein improving detected signal quality includes mitigating the effects of error propagation using the EPP estimation, wherein said mitigating includes determining whether to apply a filter based on the estimated EPP.

3. The system of claim 2 wherein said communication system is a Multiple Input Multiple Output (MIMO) system comprising:
a receiver that compares said estimated EPP to a threshold and applies a Minimum Mean Squared Error (MMSE) detection filter when said threshold is exceeded.

4. The system of claim 1, wherein said improving detected signal quality includes mitigating the effects of error propagation using the EPP estimation, wherein said mitigating includes applying weighting to detected signals based on the estimated EPP before decoding said detected signals.

5. The system of claim 1, wherein said estimated EPP is calculated using a posteriori information (API) of the received signals.

6. The system of claim 1, including a decision feedback-based technique that performs interference subtraction for each of said received signals.

7. The system of claim 1 comprising a Multiple Input Multiple Output (MIMO) system using a coded Vertical Bell Labs Layered Space Time (V-BLAST) detection technique.

8. The system of claim 1 wherein said unit for computing an estimated EPP and said unit for receiving said EPP and improving said detected signal quality are included in a processor-based device that is part of a wireless receiver apparatus.

9. The system of claim 1, wherein said wireless receiver apparatus is a Code Division Multiple Access (CDMA) enabled apparatus.

10. The system of claim 1 wherein said unit for computing an estimated EPP and said unit for receiving said EPP and improving said detected signal quality are included in a chipset for use in a wireless device.

11. A method for improving detected signal quality, the method comprising:
receiving a plurality of signals;
calculating Error Propagation Probability (EPP) for each of said received signals; and
applying the calculated EPP to mitigate the effects of error propagation in said received signals.

12. The method of claim 11 wherein said detection of said received signals comprises:
mapping received symbols to a plurality of bits.

13. The method of claim 11 wherein said receiving a plurality of signals:
performing an interference subtraction technique on the received signals, wherein an interference subtraction at a given signal affects an interference subtraction at a subsequent signal.

14. The method of claim 11 wherein said applying said EPP comprises:
comparing said calculated EPP to a threshold value and applying a Minimum Mean Squared Error (MMSE) detecting technique in response to a determination that said threshold has been exceeded.

15. The method of claim 11 wherein said applying said EPP comprises:
detecting said received signals;
assigning weights to said detected signals based upon said calculated EPP; and
performing decoding on said detected signals, wherein said assigned weights affect said decoding.

16. The method of claim 11 further comprising:
mapping said received signals to bits;
decoding said bits; and
processing the data representing said bits.

17. The method of claim 11 wherein said received signals are coded according to a Quadrature Amplitude Modulation (QAM) scheme.

18. The method of claim 11 wherein said calculating EPP comprises:
calculating said EPP for each of said received signals based, at least in part, on a posteriori information for said received signals.

19. A computer program product having a computer readable medium having computer program logic recorded thereon for mitigating the effects of error propagation in received data, said computer program product comprising:
code, when executed by a computer, receiving a plurality of symbols;
code, when executed by a computer, calculating a value representing Error Propagation Probability (EPP) for each of said received symbols;
code, when executed by a computer, applying said values of EPP during processing of said symbols to mitigate error propagation; and
code, when executed by a computer, mapping said symbols to bits.

20. The computer program product of claim 19 wherein said code applying said values of EPP comprises:
code, when executed by a computer, performing detection of said symbols; and
code, when executed by a computer, assigning weights to said detected symbols based, at least in part, on said calculated values of EPP.

21. The computer program product of claim 19 wherein said code applying said values of EPP comprises:
code, when executed by a computer, comparing said calculated values of EPP to a threshold; and
code, when executed by a computer, applying a detection technique that does not use decision feedback in response to a determination that said threshold is exceeded by one or more calculated values of EPP.

22. The computer program product of claim 21 wherein said detection technique that does not use decision feedback comprises a Minimum Mean Squared Error (MMSE) technique.
